(19) United States
(12) Patent Application Publication
(10) Pub. No.: US 2017/0204575 A1
(43) Pub. Date: Jul. 20, 2017

(54) MOVABLE MODULAR VEHICLE BARRIER

(71) Applicant: Amos KLEIN, Haifa (IL)

(72) Inventor: Amos KLEIN, Haifa (IL)

(21) Appl. No.: 15/302,028

(22) PCT Filed: Aug. 25, 2015
(86) PCT No.: PCT/IL2015/050850

§ 371 Date: Oct. 5, 2016

Related U.S. Application Data
(60) Provisional application No. 62/041,676, filed on Aug. 26, 2014.

(51) Int. Cl. E01F 13/12; E01F 13/04; E06B 11/02; E01F 15/14

(52) U.S. Cl. CPC E01F 13/12; E01F 15/14; E01F 13/04; E06B 11/027

(57) ABSTRACT

A movable modular vehicle barrier (10) formed from at least two modular units (12). Each modular unit is foldable and comprising: a base bar (14), a reclining bar (16) hingedly connected to the base bar, a horizontal reclining bar (38) hingedly connected to the base bar, and a vertical reclining bar (42) hingedly connected to the reclining bar. In a folded position of the modular unit the base bar, the reclining bar, the horizontal reclining bar and the vertical reclining bar are substantially parallel to each other. In an operative position of the modular unit, the reclining bar forms with the base bar an internal angle that is not smaller than ninety degrees, the horizontal reclining bar is perpendicular to two adjacent base bars, and the vertical reclining bar is perpendicular to two adjacent reclining bars. The barrier includes a moving system for enabling manual movement of the barrier.

### FIELD OF THE INVENTION

The present invention relates to the field of modular vehicle barriers and more particularly to the field of movable modular vehicle barriers.

### BACKGROUND OF THE INVENTION

In many sites it may be necessary to install a vehicle barrier. These sites may include, e.g., governmental offices, army bases, protected sites, etc.

Sometimes, it is not practical, due to time and budget restrictions, to build a permanent and massive vehicle barrier. In those cases, it is much more practical to quickly erect a modular vehicle barrier that can be assembled in minutes and quickly disassembled when it is no longer required. When referring to a vehicle barrier, reference is made to a barrier that actually stops a quick driving vehicle and prevents it from advancing over the barrier, and not just puncturing the vehicle's wheels as is common in most road barriers erected by the police or the army. This is especially advantageous if the vehicle carries explosives for a hostile action, whether the vehicle is driven by a suicidal terrorist, or, if the vehicle is driven from a remote location.

Sometimes, a single unit of the modular vehicle barrier is not so heavy to be handled by a single person, however, when a multitude of units are connected together, the total weight can no longer be handled by one or two persons. In those cases, it may be necessary to be aided by a power tool such as a forklift, tractor, crane, winch and the like, for moving the modular vehicle barrier.

It is the object of the present invention to provide a modular vehicle barrier that can be easily and quickly erected and dismantled and can be easily and quickly moved or rotated by one or two persons.

It is a further object of the present invention to provide a movable modular vehicle barrier that can serve as a gate to a road. Thus, in an operating position of the movable modular vehicle barrier it may completely block the entire width of a road to be blocked, and, in an open position of the movable modular vehicle barrier it may be rotated in order to partially or entirely open the road to passage of vehicles therethrough.

It is still a further object of the present invention to provide a movable modular vehicle barrier that can be easily and quickly rotated by one or two persons in order to serve a gate to a road.

### SUMMARY OF THE INVENTION

The barrier of the present invention is not limited to a certain road width since it is formed from independent modular units. Therefore, the barrier of the present invention may be used for any road width.

The barrier of the present invention may me moved or rotated by one or two persons.

When a vehicle hits the barrier, it is immediately stopped by the barrier, whether by a reclining bar, a vertical reclining bar, spikes on the horizontal reclining bar, or when the entire barrier tilts in the moving direction and the vehicle remains hanged on the now upstanding base bars.

The movable modular vehicle barrier according to the present invention is formed from at least two modular units, each modular unit is foldable and comprising:
a base bar,
a reclining bar hingedly connected to the base bar,
a horizontal reclining bar hingedly connected to the base bar, and
a vertical reclining bar hingedly connected to the reclining bar, wherein:
in a folded position of the modular unit the base bar, the reclining bar, the horizontal reclining bar and the vertical reclining bar are substantially parallel to each other, and
in an operative position of the modular unit, the reclining bar forms with the base bar an internal angle that is not smaller than ninety degrees,
the horizontal reclining bar is perpendicular to two adjacent base bars, and
   the vertical reclining bar is perpendicular to two adjacent reclining bars.

Typically, in a folded position of the horizontal reclining bar the horizontal reclining bar is secured to the base bar by means of a horizontal quick locking pin, and
in an operative position of the horizontal reclining bar the horizontal reclining bar is secured by means of the horizontal quick locking pin to an adjacent base bar.

Further typically, in a folded position of the vertical reclining bar the vertical reclining bar is secured to the reclining bar by means of a vertical quick locking pin, and
in an operative position of the vertical reclining bar the vertical reclining bar is secured by means of the vertical quick locking pin to an adjacent reclining bar.

If desired, the reclining bar is secured to the base bar by means of a belt, wherein
in a folded position of the reclining bar the belt is loose, and
in an operative position of the reclining bar the belt is stretched.

Further if desired, both ends of the belt are secured within a belt receiving connector.

Preferably, a rearward portion of the base bar is provided with a heel in a lower side of the base bar.

Further preferably, a rearward and downward portion of the reclining bar is provided with a rearwardly and downwardly directed plowing projection.

In some embodiments, in an operative position of the modular unit, the reclining bar forms with the base bar an internal angle that is larger than ninety degrees.

Advantageously, a forward portion of the base bar is provided with a receiving ramp that is slanted forwardly and downwardly.

Preferably, the movable modular vehicle barrier is provided with a moving system that enables manual translation of the movable modular vehicle barrier, and wherein

the translation includes linear movement and/or rotational movement of the movable modular vehicle barrier with respect to ground.

Advantageously, the moving system comprises a main rod, rotatable about a main rotation axis, which is detachably connected to each of the base bars and is formed from a multitude of main rod segments that are connected therebetween.

Practically, each of the main rod segments comprises a male insertion portion, at a first side thereof, and, a female receiving portion at a second side thereof, and
the main rod segments are assembled by inserting the male insertion portion of a given main rod segment into the female receiving portion of an adjacent main rod segment.

In some embodiments, a supporting bracket is attached to each of the base bars, the supporting bracket comprises at least one leading cylinder for receiving therein the main rod.

If desired, the supporting bracket comprises two spaced apart enclosed leading cylinders.

Practically, the at least one leading cylinder enables axial and rotational movement of the main rod with respect to the supporting bracket, and
the main rod is provided with at least one limiting screw for limiting axial and rotational movement of the main rod with respect to the supporting bracket.

Preferably, a main moving assembly is connected to the main rod between two adjacent base bars, the main moving assembly comprises a generally downwardly directed main wheel;
an auxiliary wheel is connected to a front portion of each of the base bars and extending downwardly therefrom; and
an operation handle is connected at least at one end of the main rod; and wherein
in a rest position angle of the operation handle, a rear portion of each of the base bars rests on a heal, and, moving of the movable modular vehicle barrier is prevented, and
in a moving position angle of the operation handle, the rear portion of each of the base bars is supported by a main wheel, the heal is elevated from ground, and, moving of the movable modular vehicle barrier is enabled.

Typically, the rest position angle of the operation handle is between 25 degrees and 45 degrees, taken rearwardly from a vertical reference line passing through the main rotation axis; and
the moving position angle of the operation handle is between 15 degrees and 35 degrees, taken forwardly from the vertical reference line.

If desired, each of the horizontal reclining bars is provided with upwardly extending spikes.

### BRIEF DESCRIPTION OF THE DRAWINGS

For a better understanding of the present invention and to show how the same may be carried out in practice, reference will now be made to the accompanying drawings, in which:

FIG. 1 is a side view of a modular unit of the movable modular vehicle barrier according to the present invention prior to opening into active position;

FIG. 2 is a perspective view of a row of modular units of FIG. 1;

FIG. 3 is a side view of the modular unit of FIG. 1 when brought into active position;

FIG. 4 is a perspective view of several modular units connected together in an active position;

FIG. 5 is a perspective view of the basic components of the moving system;

FIG. 6 is a side view of the moving system in a non-moving position; and

FIG. 7 is a side view of the moving system in a moving position.

### DESCRIPTION OF PREFERRED EMBODIMENTS

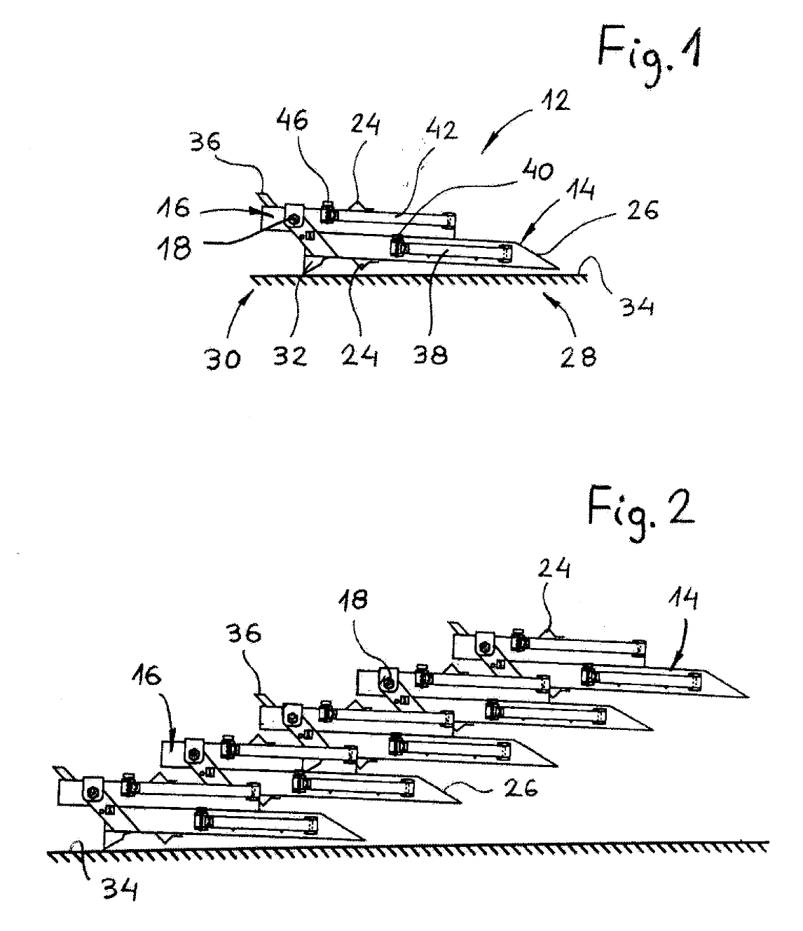

Attention is drawn to FIGS. 1-4 that show a movable modular vehicle barrier 10 according to the present invention. For sake of convenience, the movable modular vehicle barrier 10 will hereinafter be called the “barrier”.

The barrier 10 consists a multitude of modular units 12 that, when connected to each other, form the barrier 10.

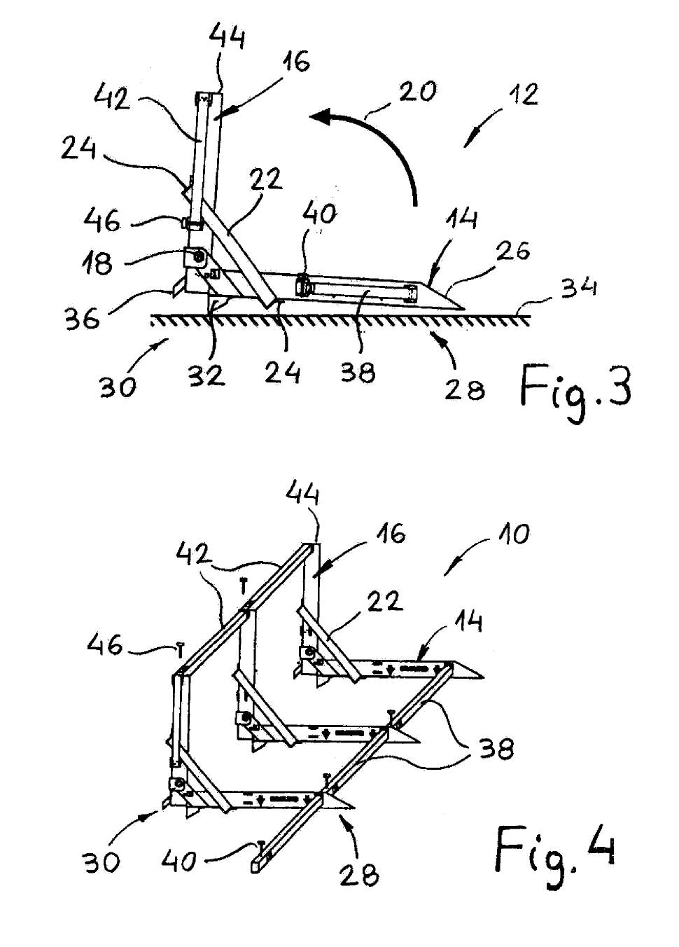

Each modular unit 12 comprises a base bar 14 and a reclining bar 16 that is rotatable with respect to the base bar 14 around an activating pivot 18. When the reclining bar 16 is brought into an active position, i.e., is rotatable with respect to the activating pivot 18 in a counter-clockwise direction, as shown by the arrow showing the activating direction 20 in FIG. 3, the reclining bar 16 is substantially perpendicular to the base bar 14.

It should be noted that directional terms appearing throughout the specification and claims, e.g. “forward”, “rear”, “upper”, “lower” etc., are used as terms of convenience to distinguish the location of various surfaces relative to each other. These terms are defined with reference to the figures, however, they are used for illustrative purposes only, and are not intended to limit the scope of the appended claims.

In some embodiments, each modular unit 12 comprises a flexible belt 22 that adds rigidity to the barrier 10, thus ensuring that the reclining bar 16 will not increase its relative position with respect to the base bar 14 and it will remain perpendicular thereto even after being activated by a threatening vehicle as will be later described. Each belt 22 is located within suitable belt receiving connectors 24 that are connected to the base bar 14 and to the reclining bar 16 and prevent sliding of the belt 22 toward the activating pivot 18.

The modular unit 12 is provided with a receiving ramp 26 in a forward portion 28 of the modular unit 12. The receiving ramp 26 is slanted forwardly thus enabling to receiving thereon a wheel of a threatening vehicle in a case that the wheel rolls on the receiving ramp 26 and not to the sides thereof.

The modular unit 12 is provided, in a rearward portion 30 thereof, with a rearwardly and downwardly pointing heel 32 that protrudes downwardly from the base bar 14 and helps inserting and affixing the barrier 10 into ground 34 in a case of a collision by a threatening vehicle. A plowing projection 36 protrudes rearwardly and downwardly from the reclining bar 16 in an active position of the modular unit 12.

A horizontal reclining bar 38 is pivotally connected to the base bar 14 adjacent the forward portion 28 of the modular unit 12 and near a top portion of the receiving ramp 26. The horizontal reclining bar 38 is secured to the base bar 14 in a folded position by means of a horizontal quick locking pin 40. A vertical reclining bar 42 is pivotally connected to the reclining bar 16 adjacent an upper end 44 of the reclining bar 16. The vertical reclining bar 42 is secured to the reclining bar 16 in a folded position by means of a vertical quick locking pin 46.

In order to assemble the barrier 10, the modular units 12 are placed on ground 34, parallel to each other, and spaced apart a distance that corresponds with a length of the horizontal reclining bar 38 and of the vertical reclining bar 42. Now, each horizontal quick locking pin 40 is released thus unlocking the corresponding horizontal reclining bar 38, rotating each horizontal reclining bar 38 up to the adjacent modular unit 12, and, locking each horizontal reclining bar 38 to the adjacent modular unit 12 by means of the free horizontal quick locking pin 40.

Similarly, each vertical quick locking pin 46 is released thus unlocking the corresponding vertical reclining bar 42, lifting each vertical reclining bar 42 up to the adjacent modular unit 12, and, locking each vertical reclining bar 42 to the adjacent modular unit 12 by means of the free vertical quick locking pin 46.

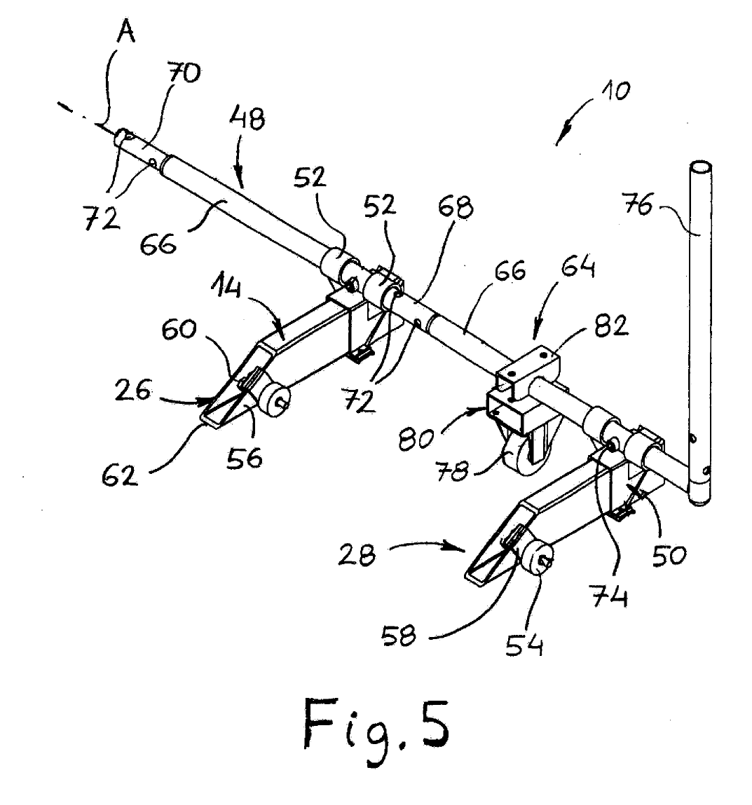

Reference is now made to FIGS. 5 to 7 for describing a moving system 48 of the barrier 10. For a matter of simplicity, only parts participating with the moving system 48 are shown.

Each of the base bars 14 is provided with a supporting bracket 50 that is connected thereto. Two spaced apart hollow leading cylinders 52 are connected at an upper portion of the supporting bracket 50. The leading cylinders 52 are spaced apart a distance that enables the reclining bar 16 to rest therebetween. In some cases, the leading cylinders 52 are not formed as closed cylinders or pipe-shaped cylinders, and they are formed with a longitudinal slot (not shown in the figures) along their entire length. In these cases, the longitudinal slot enables to pass therethrough some parts that their overhaul diameter extends beyond the internal diameter of the leading cylinders 52.

The forward portion 28 of the modular unit 12 is provided with an auxiliary wheel 54 that is connected to a side wall 56 of the receiving ramp 26. Typically, the auxiliary wheel 54 is mounted on, and freely rotate with respect to, a connecting frame 58 that is connected to the side wall 56 by means of one or more tightening bolts 60. The auxiliary wheel 54 is mounted such that it protrudes downwardly below a base bar lower surface 62 of the base bar 14, in a side view of the base bar 14.

The moving system 48 further comprises a plurality of main moving assemblies 64. Each main moving assembly 64 comprises a main rod 66. The main rod 66 has a diameter that is slightly smaller than a diameter of a leading cylinder 52. Thus, each main rod 66 can freely slide and rotate within the leading cylinders 52.

Each main rod 66 is provided with a female receiving portion 68, at a first end thereof, and, with a male insertion portion 70, at a second end thereof. Both the female receiving portion 68 and the male insertion portion 70 are provided with corresponding assembling holes 72. Furthermore, the outer diameter of the male insertion portion 70 is slightly smaller than the inner diameter of the female receiving portion 68, such that the male insertion portion 70 can fit into the female receiving portion 68.

In order to assemble the moving system 48 of the barrier 10, the main rod 66 of each main moving assembly 64 is inserted through a pair of leading cylinders 52, at a first side thereof, and, connected to another main rod 66, at a second side thereof. The main rods 66 are connected to each other by inserting the male insertion portion 70 of a first main rod 66 to the female receiving portion 68 of a second main rod 66. Then, the two main rods 66 are slightly turned with respect to each other until the location of the assembling holes 72 of the male insertion portion 70 fits the location of the assembling holes 72 of the female receiving portion 68. At this stage, a fixing pin (not shown) is inserted into at least one assembling hole 72 in order to fix the first main rod 66 to the second main rod 66. This process is repeated across the entire width of the assembled barrier 10.

In order to limit the rotation of the main rods 66 with respect to the base bars 14, a limiting screw 74 is inserted into the main rod 66 between each pair of leading cylinders 52. Typically, two limiting screws 74, generally opposite to each other, are inserted between each pair of leading cylinders 52. Despite limiting the rotation of the main rods 66, as will be later described, the limiting screws 74 also prevent unintentional excessive longitudinal sliding of the main rods 66 with respect to the base bars 14.

Now, as a final assembling step of the moving system 48, an operation handle 76 is attached to an open end of a main rod 66, at least at one side of the barrier 10. Typically, for ease of operation, an operation handle 76 is attached at both sides of the barrier 10. The operation handle 76 is attached to a main rod 66 in the same manner as the main rods 66 are connected to each other.

Since, as described above, in some embodiments the leading cylinders 52 are provided with a longitudinal slot, the assembling of the main rods 66 into the leading cylinders 52 becomes easier since at least one limiting screw 74 may freely pass through the longitudinal slot. Thus, only one limiting screw 74 will have to be screwed into its receiving thread when the main rod 66 is already assembled into the leading cylinders 52.

A main wheel 78, assembled on a wheel base 80, is attached to the main rod 66 by means of a tightening bridge 82. According to one embodiment, the main wheel 78 can turn on a line that is parallel to the tightening bridge 82.

According to another embodiment, the main wheel 78 may further rotate around a vertical axis that is perpendicular to ground 34.

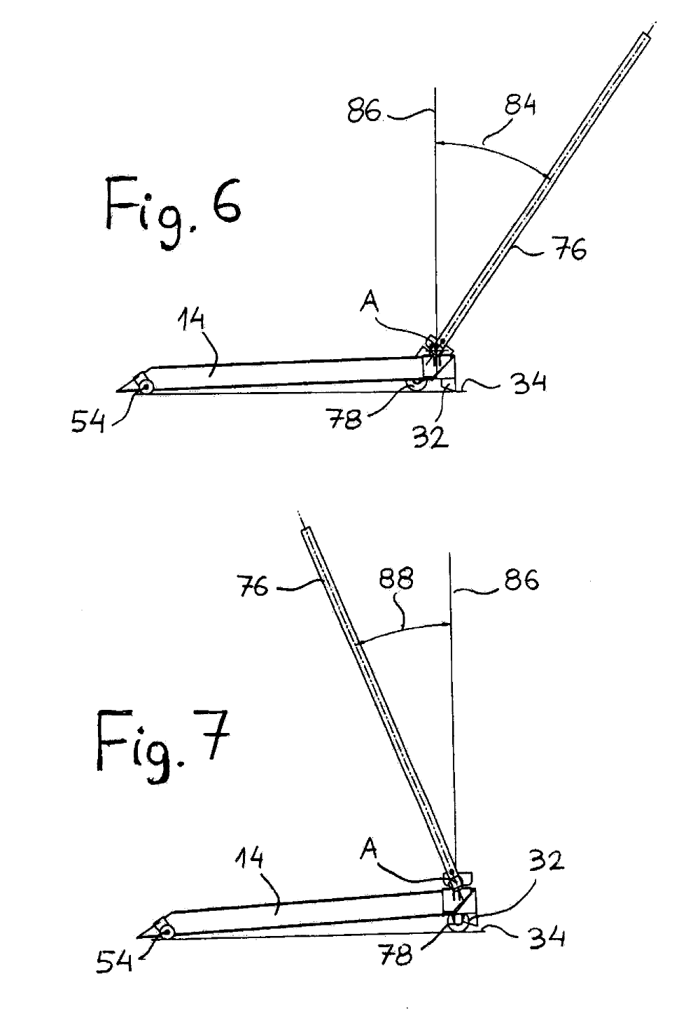

In a non-moving position of the moving system 48, the main rods 66 are oriented such that the main wheels 78 are slightly in the air, or, barely touching ground 34. In this position, the operation handle 76 is slanted rearwardly, i.e., away from the receiving ramps 26, a rest position angle 84 with respect to a reference line 86 that is vertical to ground 34 as seen in FIG. 6. Furthermore, in this position, the heel 32 of each base bar 14 rests firmly on the ground 34 by the weight of the entire barrier 10.

Practically, for comfortability of operation of the moving system 48, the rest position angle 84 is chosen to be between 0 degrees and 45 degrees. According to a specific embodiment of the present invention, the rest position angle 84 is 35 degrees.

When it is desired to move the barrier 10, whether along a straight line parallel to the base bars 14, or, horizontally rotate the entire barrier 10 around any portion thereof, it is required to bring the main wheels 78 into a moving position. For that purpose, the operation handle 76 is pulled forwardly, i.e., toward the receiving ramps 26, to a moving position angle 88 with respect to the reference line 86 as seen in FIG. 7. Practically, for comfortability of operation of the moving system 48, the moving position angle 88 is chosen to be between 0 degrees and 45 degrees. According to a specific embodiment of the present invention, the moving position angle 88 is 23 degrees.

When the operation handle 76 is moved from the rest position to the moving position, since the multitude of main rods 66 are connected to each other they roll together as a unitary piece within the leading cylinders 52. Now, since the main wheels 78 are connected to the main rods 66 through the corresponding wheel bases 80 that are secured by the tightening bridges 82, they roll together with the main rods 66 a moving angle, that is the sum of the rest position angle 84 and the moving position angle 88, around a main rotation axis A of the main rods 66.

The above mentioned rotation of the main wheels 78 forces the rearward portion 30 of the modular units 12 to lift from the ground 34, and, as can be seen in FIG. 7, in the moving position of the barrier 10, the heel 32 is lifted from the ground 34. Now, all the modular units 12 of the entire barrier 10 rest on the main wheels 78, at their rearward portion 30, and, on the auxiliary wheels 54, at their forward portion 28.

In order to set the right position of the operation handle 76, both in the rest position and in the moving position, the limiting screws 74 provided on the main rods 66 between each pair of leading cylinders 52, set the maximum stroke of the operation handle 76 towards a given direction.

In this position, the barrier 10 can be easily moved or rotated by one or two persons holding the operation handles 76. When two persons are involved, the barrier 10 can be easily pushed or pulled in a straight line, forwardly or rearwardly, or, rotated in each desired direction.

Although the present invention has been described to a certain degree of particularity, it should be understood that various alterations and modifications could be made without departing from the spirit or scope of the invention as hereinafter claimed.

For example, the rotation limiting of the operation handle 76 does not have to be carried out by limiting screws 74 and other means may be involved.

The wheel base 80 does not have to be fastened to the main rod 66 by means of a tightening bridge 82, and it may be directly connected to the main rod 66, by welding, bolts passing through the main rod, or the like.

The auxiliary wheels 54 do not have to be connected to the base bars 14 by means of connecting frames 58 that are fastened by tightening bolts 60, and they may be directly connected to the base bars 14.

The reclining bar 16 does not have to be perpendicular to the base bar 14. According to some embodiments, the reclining bar 16 forms with the base bar 14 an angle that is greater than 90°, for example, 120°. This feature assures that the barrier will tilt and locked against the road even if it is hit by a short car. Furthermore, according to other embodiments, the reclining bar is not formed from a straight beam, but, from a curved beam, that is curved forwardly in the driving direction for the same reason of enabling easier tilting of the barrier.

In the embodiment shown, the ramp 26 is open to the base bar 14 for enabling fixing the connecting frame 58 of the auxiliary wheel 54 to the side wall 56 by means of the tightening bolt 60. However, in other embodiments, the ramp 26 is closed and not open to the base bar 14. In this case, the auxiliary wheel 54 is attached to the base bar 14 in other way.

In some embodiments, each of the horizontal reclining bars 38 is provided with a multitude of spaced apart upwardly directed spikes (not shown in the figures). The spikes provide extra protection against a threatening vehicle and they ensure puncturing of the front wheels of the vehicle.

The auxiliary wheels 54 may be directly assembled on their shaft and freely rotate with respect thereto. Alternatively, the auxiliary wheels 54 may be provided with bearings, thus enabling easier rotation thereof.

1. A movable modular vehicle barrier formed from at least two modular units, each modular unit being foldable and comprising:
a base bar,
a reclining bar hingedly connected to the base bar wherein the reclining bar is secured to the base bar by means of a belt,
a horizontal reclining bar hingedly connected to the base bar, and
a vertical reclining bar hingedly connected to the reclining bar,
wherein:
in a folded position of the modular unit the base bar, the reclining bar, the horizontal reclining bar,, and the vertical reclining bar are substantially parallel to each other and the belt is loose, and
in an operative position of the modular unit, the reclining bar forms with the base bar an internal angle that is not smaller than ninety degrees while the belt is stretched,
the horizontal reclining bar is perpendicular to two adjacent base bars, and
the vertical reclining bar is perpendicular to two adjacent reclining bars.

2. The movable modular vehicle barrier according to claim 1, wherein:
in a folded position of the horizontal reclining bar the horizontal reclining bar is secured to the base bar by means of a horizontal quick locking pin, and
in an operative position of the horizontal reclining bar the horizontal reclining bar is secured by means of the horizontal quick locking pin to an adjacent base bar.

3. The movable modular vehicle barrier according to claim 1, wherein:
in a folded position of the vertical reclining bar the vertical reclining bar is secured to the reclining bar by means of a vertical quick locking pin, and
in an operative position of the vertical reclining bar the vertical reclining bar is secured by means of the vertical quick locking pin to an adjacent reclining bar.

4. (canceled)

5. The movable modular vehicle barrier according to claim 1, wherein:
both ends of the belt are secured within a belt receiving connector.

6. The movable modular vehicle barrier according to claim 1, wherein a rearward portion of the base bar is provided with a heel in a lower side of the base bar.

7. The movable modular vehicle barrier according to claim 1, wherein a rearward and downward portion of the reclining bar is provided with a rearwardly and downwardly directed plowing projection.

8. The movable modular vehicle barrier according to claim 1, wherein in the operative position of the modular unit, the reclining bar forms with the base bar an internal angle that is larger than ninety degrees.

9. The movable modular vehicle barrier according to claim 1, wherein a forward portion of the base bar is provided with a receiving ramp that is slanted forwardly and downwardly.

10. A movable modular vehicle barrier formed from at least two modular units, each modular unit being foldable and comprising:
a base bar,
a reclining bar hingedly connected to the base,
a horizontal reclining bar hingedly connected to the base bar, and
a vertical reclining bar hingedly connected to the reclining bar,
a moving system that enables manual translation of the movable modular vehicle barrier, wherein
in a folded position of the modular unit the base bar, the reclining bar, the horizontal reclining bar and the vertical reclining bar are substantially parallel to each other, and
in an operative position of the modular unit, the reclining bar forms with the base bar an internal angle that is not smaller than ninety degrees,
the horizontal reclining bar is perpendicular to two adjacent base bars, and
the vertical reclining bar is perpendicular to two adjacent reclining bars, and wherein
the translation includes linear movement and/or rotational movement of the movable modular vehicle barrier with respect to ground.

11. The movable modular vehicle barrier according to claim 10, wherein the moving system comprises a main rod, rotatable about a main rotation axis (A), which is detachably connected to each of the base bars and is formed from a multitude of main rod segments that are connected therebetween.

12. The movable modular vehicle barrier according to claim 11, wherein each of the main rod segments comprises a male insertion portion, at a first side thereof, and a female receiving portion at a second side thereof, and
the main rod segments are assembled by inserting the male insertion portion of a given main rod segment into the female receiving portion of an adjacent main rod segment.

13. The movable modular vehicle barrier according to claim 11, wherein a supporting bracket is attached to each of the base bars, and the supporting bracket comprises at least one leading cylinder for receiving therein the main rod.

14. The movable modular vehicle barrier according to claim 13, wherein the supporting bracket comprises two spaced apart enclosed leading cylinders.

15. The movable modular vehicle barrier according to claim 13, wherein:
the at least one leading cylinder enables axial and rotational movement of the main rod with respect to the supporting bracket, and
the main rod is provided with at least one limiting screw for limiting axial and rotational movement of the main rod with respect to the supporting bracket.

16. The movable modular vehicle barrier according to claim 11, wherein a main moving assembly is connected to the main rod between two adjacent base bars, the main moving assembly comprises a generally downwardly directed main wheel;
an auxiliary wheel is connected to a front portion of each of the base bars and extending downwardly therefrom; and
an operation handle is connected at least at one end of the main rod; and wherein
in a rest position angle of the operation handle, a rear portion of each of the base bars rests on a heal that is pressed into a ground onto which the barrier is positioned, and moving of the movable modular vehicle barrier is prevented, and
in a moving position angle of the operation handle, the rear portion of each of the base bars is supported by a main wheel, the heal is elevated from the ground, and moving of the movable modular vehicle barrier is enabled.

17. The movable modular vehicle barrier according to claim 16, wherein the rest position angle of the operation handle is between 25 degrees and 45 degrees, taken rearwardly from a vertical reference line passing through the main rotation axis (A); and
the moving position angle of the operation handle is between 15 degrees and 35 degrees, taken forwardly from the vertical reference line.

18. The movable modular vehicle barrier according to claim 1, wherein each of the horizontal reclining bars is provided with a multitude of upwardly extending spikes.
